(19) United States
(12) Patent Application Publication
(10) Pub. No.: US 2025/0094820 A1
(43) Pub. Date: Mar. 20, 2025

(54) ENABLING DEVICE CONTROL PLANNING CAPABILITIES OF SMALL LANGUAGE MODEL

(71) Applicant: SAMSUNG ELECTRONICS CO., LTD., Suwon-si (KR)

(72) Inventors: Sudipta PAUL, Sunnyvale, CA (US); Lingyu ZHANG, Cupertino, CA (US); Yilin SHEN, Mountain View, CA (US); Hongxia JIN, San Jose, CA (US)

(73) Assignee: SAMSUNG ELECTRONICS CO., LTD., Suwon-si (KR)

(21) Appl. No.: 18/824,166

(22) Filed: Sep. 4, 2024

Related U.S. Application Data
(60) Provisional application No. 63/538,671, filed on Sep. 15, 2023.

(51) Int. Cl. G06N 3/096

(52) U.S. Cl. CPC G06N 3/096

(57) ABSTRACT

A method for enabling an improved device control capability of a small language model (SLM) transferrable to a hub device configured to be operable by a user in an environment, is disclosed. The method includes performing a fine-tuning the SLM based on a data set including base plans and contrastive plans; generating computer codes corresponding to the fine-tuned SLM; and transferring the generated computer codes to the hub device to be connected with a group of the electronic devices in the environment.

### CROSS-REFERENCE TO RELATED APPLICATIONS

This application is based on and claims priority under 35 U.S.C. § 119 to U.S. Patent Provisional Application No. 63/538,671, filed on Sep. 15, 2023, in the United States Patent and Trademark Office, the disclosure of which is incorporated by reference herein in its entirety.

### BACKGROUND

### 1. Field

The disclosure relates to a system and a method for controlling electronic devices using language models (such as a small language model), for example, home devices or industrial devices.

### 2. Description of Related Art

Controlling electronic devices (e.g., smart home devices, industrial devices at factories) is a difficult task if the instruction is abstract and the planner needs to adjust dynamic configurations. Language models (in particular, large language model (LLM)) may be used for ‘zero-shot’ planning tasks. That is, based on already containing information, without further training, the LLM may perform high-level tasks such as planning action tasks in accordance with a user's input instruction (e.g., a prompt).

In some cases, (cloud-supported) LLMs may seamlessly perform controlling the electronic devices. However, small language models(SLMs) (e.g., on-device) show limited capabilities for controlling the electronic devices. Examples of the (cloud-supported) LLMs have tens of billions to hundreds of billions of learnable parameters. Examples of SLMs may have only about several billion learnable parameters.

One example of controlling the electronic devices is to control home appliances or devices. For example, a user of the home devices (an automated system connected with a window and a light) provides an ambiguous/abstract/indirect instruction, such as saying “this room is too bright,” then the automated system may (plan to) close the window and/or dim the light.

One example of the automated system is a ‘Smart Home AI Assistant’ configured to perform the above operations on the connected devices (e.g., the window and the light) based on the user instruction. To perform the task of controlling the connected devices, the automated system needs to understand the intent of the user instruction and to develop a plan to achieve the intended goal. It may be complex for the automated system to adjust the plan based on a configuration of an environment (e.g., a house including the window, the light, and/or other available devices) where the automated system is located at.

When working with LLMs, it is important to provide the right ‘prompt’. So-called ‘prompt engineering’ involves carefully designing this input text to guide the LLM towards generating the desired response. ‘In-context learning’ (ICL) takes things a step further than the prompt engineering. The ICL involves adding examples or extra information directly within the prompt. By receiving ‘in-context examples’ from the user, which are used for the ICL of the LLM, the LLM may grasp the task at hand and deliver even more accurate and relevant outputs. There are different flavors of in-context learning; zero-shot, single-shot, and few-shot, which refer to a number of examples provided to the LLM. Recently, the LLMs have shown promising capability as a ‘zero-shot’ action planner in multiple cases. With the aid of proper ‘in-context examples,’ the LLMs may perform aforementioned planning task for different configurations seamlessly.

However, the LLMs may have billions of learnable parameters and may be implemented in servers having powerful computational capabilities, but may not be deployed on (relatively) small devices with limited memory, such as a hub device, a small home appliance, or a smart phone.

One possible solution is to use SLMs that may be deployed on (relatively) small devices as a proxy for LLMs. However, the performance of SLMs may be worse than that of LLMs. SLMs may infer wrong plans to control the electronic devices or may be incapable to plan to control available electronic devices.

### SUMMARY

The disclosure is directed to a system and a method for controlling electronic devices (for example, home devices or industrial devices) using language models (such as a large language model (LLM) and a small language model (SLM)).

According to an aspect of the disclosure, a method for enabling an improved device control capability of a small language model (SLM) transferrable to a hub device configured to be operable by a user in an environment, includes: generating, by using a large language model (LLM), a pool of diverse instructions including direct instructions for controlling a first group of electronic devices and indirect instructions for controlling the first group of the electronic devices, wherein the first group of the electronic devices corresponds to all available devices in the environment; generating, by using the LLM, base plans related to operations of controlling the first group of the electronic devices; determining, by using the LLM and a retrieval model, retrieved devices based on the base plans and the indirect instructions, wherein the retrieved devices correspond to a second group of the electronic devices and wherein a first number of the electronic devices in the first group is higher than a second number of the electronic devices in the second group; generating, by using the LLM, contrastive plans based on a third group of the electronic devices, wherein a third number of the electronic devices in the third group corresponds to a number of the first number minus the second number; generating a data set by combining the base plans and the contrastive plans; performing a fine-tuning the SLM based on the data set; generating computer codes corresponding to the fine-tuned SLM; and transferring the generated computer codes to the hub device to be connected with a fourth group of the electronic devices in the environment.

According to an aspect of the disclosure, a method for enabling an improved device control capability of a first language model transferrable to a hub device configured to be operable by a user in an environment, includes: generating, by using a second language model, a pool of diverse instructions including direct instructions for controlling a first group of electronic devices and indirect instructions for controlling the first group of the electronic devices, wherein the first group of the electronic devices corresponds to all available devices in the environment; generating, by using the second language model, first plans related to operations of controlling the first group of the electronic devices; determining, by using the second language model and a retrieval model, retrieved devices based on the first plans and the indirect instructions, wherein the retrieved devices correspond to a second group of the electronic devices and wherein a first number of the electronic devices in the first group is higher than a second number of the electronic devices in the second group; generating, by using the second language model, second plans based on a third group of the electronic devices, wherein a third number of the electronic devices in the third group corresponds to a number of the first number minus the second number; generating a data set by combining the first plans and the second plans; performing a fine-tuning the first language model based on the data set; generating computer codes corresponding to the fine-tuned first language model; and transferring the generated computer codes to the hub device to be connected with a fourth group of the electronic devices in the environment.

According to an aspect of the disclosure, an electronic device for enabling an improved device control capability of a small language model (SLM) transferrable to a hub device configured to be operable by a user in an environment, the electronic device comprising: at least one processor; and at least one memory including computer program code, where the at least one memory and the computer program code are configured, with the at least one processor, to cause the electronic device to at least: generate, by using a large language model (LLM), a pool of diverse instructions including direct instructions for controlling a first group of electronic devices and indirect instructions for controlling the first group of the electronic devices, wherein the first group of the electronic devices corresponds to all available devices in the environment; generate, by using the LLM, base plans related to operations of controlling the first group of the electronic devices; determine, by using the LLM and a retrieval model, retrieved devices based on the base plans and the indirect instructions, wherein the retrieved devices correspond to a second group of the electronic devices and wherein a first number of the electronic devices in the first group is higher than a second number of the electronic devices in the second group; generate, by using the LLM, contrastive plans based on a third group of the electronic devices, wherein a third number of the electronic devices in the third group corresponds to a number of the first number minus the second number; generate a data set by combining the base plans and the contrastive plans; perform a fine-tuning the SLM based on the data set; generate computer codes corresponding to the fine-tuned SLM; and transfer the generated computer codes to the hub device to be connected with a fourth group of the electronic devices in the environment.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates example components of an electronic device in accordance with embodiments of the disclosure;

FIG. 2 illustrates an example of an environment for controlling multiple electronic devices in accordance with some embodiments of the disclosure;

FIG. 3A illustrates diverse instruction generation in accordance with an embodiment of the disclosure;

FIG. 3B illustrates base plan generation in accordance with an embodiment of the disclosure;

FIG. 4A illustrates relevance device retrieval in accordance with an embodiment of the disclosure;

FIG. 4B illustrates contrastive plan generation in accordance with an embodiment of the disclosure;

FIG. 5 illustrates an embodiment about practical applications of the disclosure; and

FIG. 6 illustrates operations for generating computer codes corresponding to a fine-tuned SLM having improved device control capabilities and transferring the generated computer codes to a hub device, in accordance with an embodiment of the disclosure.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

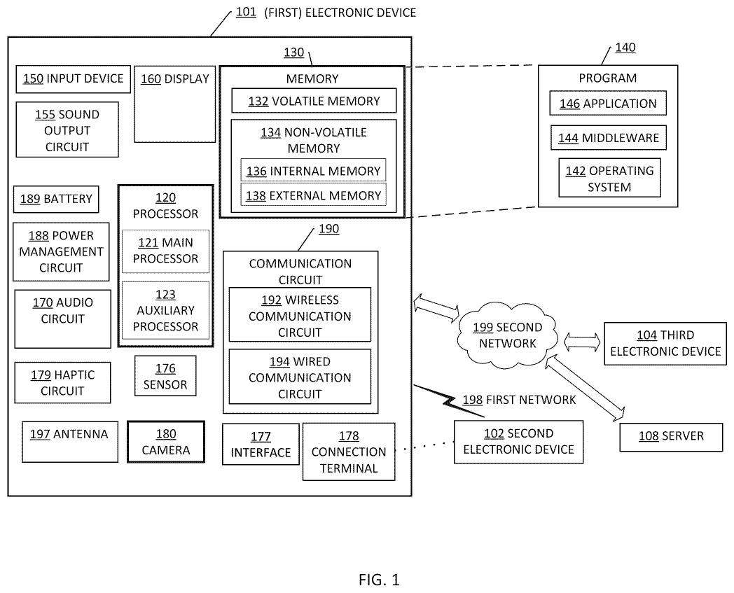

FIG. 1 illustrates example components of the electronic device in accordance with an embodiment of the disclosure.

In FIG. 1, a (first) electronic device 101 may communicate with a second electronic device 102 via a first network 198 (e.g., a short-range wireless communication network), or a third electronic device 104 or a server 108 via a second network 199 (e.g., a long-range wireless communication network). In one embodiment, the (first) electronic device 101 may communicate with the third electronic device 104 via the server 108. Throughout the disclosure, the first electronic device 101 may be referred to as ‘the electronic device 101.’ Hereinafter, components of the electronic device 101 are described. Those components of the electronic device 101 may be also included in the second electronic device 102 or the third electronic device 104. The first electronic device 101, the second electronic device 102, or the third electronic device 104 may be configured to perform methods, steps, or operations described in the disclosure.

In an embodiment, the electronic device 101 may include a processor 120, memory 130, an input device 150, a sound output circuit 155, a display 160, an audio circuit 170, a sensor 176, an interface 177, a connection terminal 178, a haptic circuit 179, a camera 180, a power management circuit 188, a battery 189, a communication circuit 190, or an antenna 197.

In an embodiment, at least one (e.g., the display 160, the sensor 176, or the camera 180) of the components may be omitted from the electronic device 101, or one or more other components may be added in the electronic device 101. In an embodiment, some of the components may be implemented as single integrated circuitry. For example, the sensor 176 (e.g., a fingerprint sensor, an iris sensor, or an illuminance sensor) may be implemented as embedded in the display 160 (e.g., a display). In an embodiment, the electronic device 101 may be a user equipment, a user terminal, a smartphone, a tablet personal computer (PC), a laptop, a PC and/or a server.

In an embodiment, the at least one processor 120 (or the main processor 121 or the auxiliary processor 123) may be implemented in hardware, firmware, or a combination of hardware and software. The at least one processor 120 (or the main processor 121 or the auxiliary processor 123) may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The at least one processor 120 (or the main processor 121 or the auxiliary processor 123) are able to perform control of any one or any combination of the other components of the computing device, and/or perform an operation or data processing relating to communication. The at least one processor 120 (or the main processor 121 or the auxiliary processor 123) execute one or more programs stored in a memory.

The at least one processor 120 (or the main processor 121 or the auxiliary processor 123) may be implemented as one or more multi-core processors that include one or more cores (e.g., homogeneous multi-cores or heterogeneous multi-cores). When a plurality of cores are included in the at least one processor 120 (or the main processor 121 or the auxiliary processor 123), each of the cores includes a cache memory, and a common cache shared by the cores may be included in the at least one processor 120 (or the main processor 121 or the auxiliary processor 123). Each of the cores may independently read and execute program instructions or each of the cores may read and execute one or more portions of program instructions.

In an embodiment, the at least one processor 120 (or the main processor 121 or the auxiliary processor 123) may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may load a command or data received from another component (e.g., the sensor 176 or the communication circuit 190) in volatile memory 132, process the command or the data stored in the volatile memory 132, and store resulting data in non-volatile memory 134.

In one embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The processor 120 may refer to or correspond to one or more processors. For example, the electronic device 101 may include two or more processors like the processor 120. In an embodiment, the main processor 121 and the auxiliary processor 123 may comprise processing circuitry.

The auxiliary processor 123 may be implemented as separate from, or as part of the main processor 121. The auxiliary processor 123 may control at least some of functions or states related to at least one component (e.g., the display 160, the sensor 176, or the communication circuit 190) among the components of the electronic device 101, instead of the main processor 121 while the main processor 121 is in an inactive (e.g., sleep) state, or together with the main processor 121 while the main processor 121 is in an active state (e.g., executing an application). In one embodiment, the auxiliary processor 123 (e.g., an image signal processor or a communication processor) may be implemented as part of another component (e.g., the camera 180 or the communication circuit 190) functionally related to the auxiliary processor 123.

For example, the processor 120 of the electronic device 101 may invoke at least one of the one or more instructions stored in the memory 130, and execute the at least one of the one or more instructions, with or without using one or more other components under the control of the processor 120. This allows the electronic device 101 to be operated to perform at least one function according to the at least one instruction invoked. The one or more instructions may include a code generated by a compiler or a code executable by an interpreter. The memory 130, which may be a machine-readable storage medium, may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the memory 130 (the storage medium) and where the data is temporarily stored in the memory 130. In an embodiment, the electronic device 101 may comprise one or more processors (e.g., the main processor 121 and the auxiliary processor 123), and the one or more instructions may be executed by the one or more processors individually or collectively, thereby causing the electronic device 101 to perform any combination of one or more operations (or functions, steps) described herein.

In an embodiment, the memory 130 may include a random-access memory (RAM), a read only memory (ROM), and/or another type of dynamic or static storage device (e.g., a flash memory, a magnetic memory, and/or an optical memory) that stores information and/or instructions for use by the processor 120. In an embodiment, the memory 130 may contain information and/or software related to the operation and use of the electronic device 100. For example, the memory 130 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, or another type of non-transitory computer-readable medium, along with a corresponding drive.

The memory 130 may store various data used by at least one component (e.g., the processor 120 or the sensor 176) of the electronic device 101. The various data may include, for example, software (e.g., the program 140) and input data or output data for a command related thereto. The memory 130 may include the volatile memory 132 or the non-volatile memory 134. The non-volatile memory 134 may include the internal memory 136 or external memory 138. The program 140 may be stored in the memory 130 as software, and may include, for example, an operating system (OS) 142, middleware 144, or an application 146.

One or more embodiments of the disclosure may be implemented as software (e.g., the operating system 142, the application 146, the middleware 144) including one or more instructions that are stored in the memory 130 (comprising one or more storage medium) that is readable by the electronic device 101.

In an embodiment, the input device 150 may receive a command or data to be used by another component (e.g., the processor 120) of the electronic device 101, from the outside (e.g., a user, the second electronic device 102, or the third electronic device 104) of the electronic device 101. The input device 150 may include, for example, a microphone, a mouse, a keyboard, a key (e.g., a button), or a digital pen (e.g., a stylus pen).

In an embodiment, the sound output circuit 155 may output sound signals to the outside of the electronic device 101. The sound output circuit 155 may include, for example, a speaker or a receiver. The speaker may be used for general purposes, such as playing multimedia or playing recorded data. The receiver may be used for receiving incoming calls. According to some embodiments, the receiver may be implemented as separate from, or as part of the speaker.

In an embodiment, the display 160 may visually provide information to the outside (e.g., a user) of the electronic device 101. The display 160 may include, for example, a display device, a hologram device, or a projector and control circuitry to control a corresponding one of the display device, hologram device, and projector. According to some embodiments, the display 160 may include a touch sensor adapted to detect a touch, or a pressure sensor adapted to measure the intensity of force incurred by the touch.

In an embodiment, the audio circuit 170 may convert a sound into an electrical signal and vice versa. According to an embodiment, the audio circuit 170 may obtain the sound via the input device 150 or output the sound via the sound output circuit 155 or a headphone of an external electronic device (e.g., the second electronic device 102 or the third electronic device 104) directly (e.g., wiredly) or wirelessly coupled with the electronic device 101.

In an embodiment, a sensor 176 may detect an operational state (e.g., power or temperature) of the electronic device 101 or an environmental state (e.g., a state of a user) external to the electronic device 101, and then generate an electrical signal or data value corresponding to the detected state.

In an embodiment, the interface 177 may support one or more specified protocols to be used for the electronic device 101 to be coupled with the external entity (e.g., the second electronic device 102, the third electronic device 104, or the server 108) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

In an embodiment, the connecting terminal 178 may include a connector via which the electronic device 101 may be physically connected with the external electronic device (e.g., the second electronic device 102, the third electronic device 104, or the server 108). According to some embodiments, the connecting terminal 178 may include, for example, an HDMI connector, a USB connector, an SD card connector, or an audio connector (e.g., a headphone connector).

In an embodiment, the haptic circuit 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

In an embodiment, the camera 180 may capture a still image or moving images (or a set or one or more still images, or video data). According to some embodiments, the camera 180 may include one or more lenses, image sensors, ISPs, or flashes.

In an embodiment, the power management circuit 188 may manage power supplied to the electronic device 101. According to some embodiments, the power management circuit 188 may be implemented as at least part of, for example, a power management integrated circuit (PMIC).

In an embodiment, the battery 189 may supply power to at least one component of the electronic device 101. According to some embodiments, the battery 189 may include, for example, a primary cell which is not rechargeable, a secondary cell which is rechargeable, or a fuel cell.

In an embodiment, the communication circuit 190 may include a transceiver-like component (e.g., a transceiver and/or a separate receiver and transmitter) that enables the electronic device 100 to communicate with other devices (e.g., the second electronic device 102, the third electronic device 104, or the server 108), such as via a wired connection, a wireless connection, or a combination of wired and wireless connections. The communication circuit 190 may permit the electronic device 100 to receive information from another device and/or provide information to another device. For example, the communication circuit 190 may include an Ethernet interface, an optical interface, a coaxial interface, an infrared interface, a radio frequency (RF) interface, a universal serial bus (USB) interface, a Wi-Fi interface, a cellular network interface, or the like. In an embodiment, the communication circuit 190 may be a communication ‘interface’ used to connect the electronic device 100 with the other devices.

In an embodiment, the communication circuit 190 may include one or more communication processors (CPs) that are operable independently from the processor 120 (e.g., an application processor) and supports a direct (e.g., wired) communication or a wireless communication. According to an embodiment, the communication circuit 190 may include a wireless communication circuit 192 (e.g., a cellular communication module, a short-range wireless communication module, or a global navigation satellite system (GNSS) communication module) or a wired communication circuit 194 (e.g., a local area network (LAN) communication module or a power line communication (PLC) module).

A corresponding one of these communication modules may communicate with the external electronic device via the first network 198 (e.g., a short-range communication network, such as Bluetooth™, Wi-Fi direct, or IR data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication circuit 192 may identify and authenticate the electronic device 101 in a communication network, such as the first network 198 or the second network 199, using subscriber information (e.g., international mobile subscriber identity (IMSI)).

The antenna 197 may transmit or receive a signal or power to or from the outside (e.g., an external electronic device) of the electronic device 101. According to an embodiment, the antenna 197 may include an antenna including a radiating element composed of a conductive material or a conductive pattern formed in or on a substrate (e.g., a printed circuit board (PCB)). According to an embodiment, the antenna 197 may include a plurality of antennas (e.g., array antennas).

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In an embodiment, a set of components (e.g., one or more components) of the electronic device 100 may perform one or more functions described as being performed by another set of components of the electronic device 100.

One aspect of the disclosure is to enable planning capabilities of controlling multiple devices by an electronic device (such as the first electronic device 101, the second electronic device 102, or the third electronic device 104) (‘device control planning capabilities’) using a small language model (SLM) without using manually annotated device control data. The SLM may generate appropriate plans based on different configurations of places where the electronic devices are located at (e.g., a user's house). One aspect of the disclosure is to use an automated approach to transfer the device control planning capabilities of an LLM to the SLM. The LLM may be used to synthesize ‘instruction-devices-plan’ triplets for device control task automatically in a self-regulatory manner. One aspect of the disclosure is to generate ‘base plans’ and ‘contrastive plans’ by systematically altering the configurations for the same instruction. One aspect of the disclosure is to fine-tune the SLM based on both of the base plans and the contrastive plans, to ensure that the SLM will adjust the device control planning capabilities for different configurations. Throughout the disclosure, the base plans refer to some device controlling capacities corresponding to all available devices, while the contrastive plans refer to other device controlling capacities corresponding to a subset of the all available devices (when at least one of the all available devices becomes unavailable).

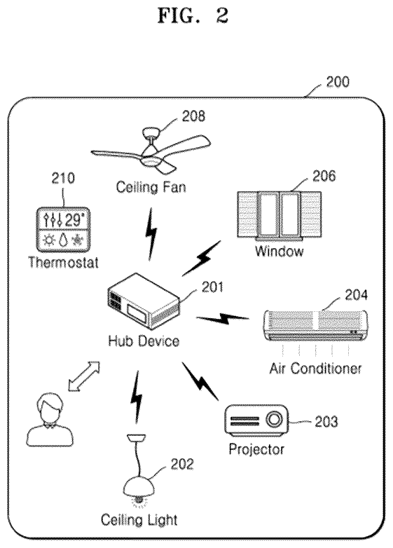

FIG. 2 illustrates an example of an environment for controlling multiple electronic devices. In a house room 200 shown in FIG. 2, a hub device 201 may be configured to connect with multiple devices, for example, a ceiling light 202, a projector 203, an air conditioner 204, a window 206, a ceiling fan 208, and a thermostat 210. The hub device 201 may correspond to the first electronic device 101, the second electronic device 102, or the third electronic device 104 shown in FIG. 1. Non-limiting examples of the hub device 201 are artificial intelligence (AI) assistant devices, smart phones, and smart home devices. In an embodiment, multiple devices, such as sensors, bulbs, outlets, actuators, or buttons, are placed and connected between a controlling device (the hub device 201) and the controlled devices (the ceiling light 202, the projector 203, the air conditioner 204, the window 206, the ceiling fan 208, and the thermostat 210).

The hub device 201 of FIG. 2 may obtain an instruction(e.g. from the server or the user), and then, the hub device 201 may enable ‘device control planning capabilities’ in accordance with embodiments of the disclosure, and then, the hub device 201 may control the controlled devices based on the device control planning capabilities.

Throughout this disclosure, the environment of the house room 200 is described as an example. However, the disclosure and its embodiments are not limited to the house room 200. In other words, the embodiments of the disclosure may be implemented or realized in other environments such as industrial places like manufacturing factories.

A set of all available devices (e.g., the ceiling light 202, the projector 203, the air conditioner 204, the window 206, the ceiling fan 208, and the thermostat 210 shown in FIG. 2) are [symbol] and a set of all possible instructions from the user are [symbol] .

In an embodiment, the set of all possible instructions may include direct instructions to directly control at least one specific device, for example, “Turn off the ceiling light.” In an embodiment, the set of all possible instructions may include indirect (abstract) instructions, for example, “this room is too hot.”

For an user instruction u∈ [symbol] and a set of available devices D⊆ [symbol] an aspect of an embodiment is to learn a language model (e.g., SLM) [symbol] that may come up with ‘n’ necessary device control plans/steps S={sᵢ}ᵢ₌₁ⁿ to achieve a goal of controlling the devices. Because manually annotating instruction-plan pairs is a tedious task for different configurations in an environment (e.g., home or a factory), a set of annotated {(u, D, S)} triplets (user instruction, device, and plan/step) may be unavailable to fine-tune the language model (e.g., SLM) [symbol] . Thus, as described below, the disclosure proposes an automated system configured to generate the set of annotated {(u, D, S)} triplets (user instruction, device, and plan/step) without manual annotations using the LLM.

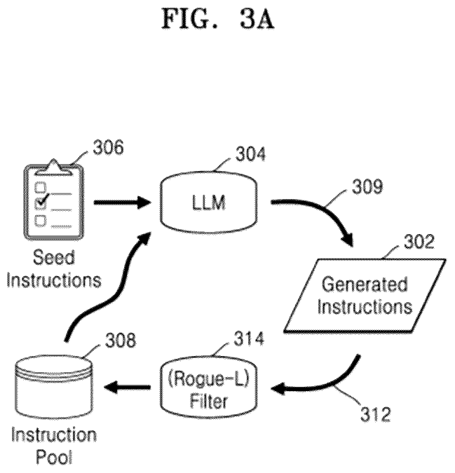

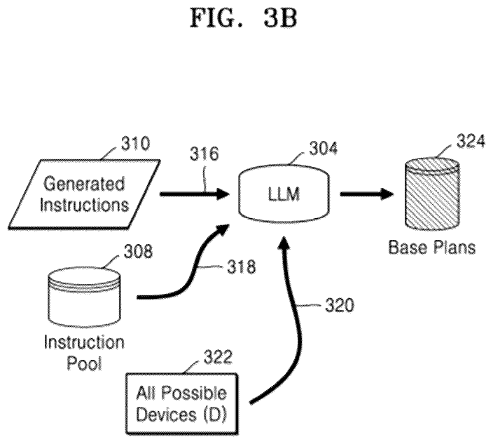

FIG. 3 illustrates diverse instruction generation using an LLM and filter in the loop in accordance with an embodiment of the disclosure. FIG. 3B illustrates base plan generation in accordance with an embodiment of the disclosure.

Transfer of knowledge (automatically generated by the LLM) from the LLM to the SLM is described below.

Pretrained SLMs typically do not perform well for device control planning task. However, the LLM may perform well with proper in-context examples. In an embodiment, knowledge from the LLM may be transferred to a SLM to enable better planning capabilities. Towards this goal, the disclosure proposes that the LLM may be used to generate data impression for device control task automatically in a self-regulatory manner. In an embodiment, the LLM may adjust plans for different configurations (e.g., different numbers of devices available at home or in a factory), thus “contrastive plans” may be generated for same instructions with the different configurations. In an embodiment, the generated data may be used to fine-tune the SLM. The overall operations of embodiments in this disclosure are illustrated in the drawings and are described below.

Diverse instruction generation is illustrated in FIG. 3A and described below. A large set of diverse instructions 302 may be generated using the LLM 304. In an embodiment, the process starts with a seed set of manually generated instructions (e.g., 30 samples) (seed instructions 306) to generate a large set of diverse instructions 302 using the LLM 304. A pool of generated (diverse) instructions (instruction pool 308) may be maintained throughout the operations shown in FIG. 3.

Some instructions (e.g., six (6) instructions) may be randomly sampled from the seed instructions 306 and some instructions (e.g., two (2) instructions) may be randomly sampled from the instruction pool 308 as “in-context examples” (shown as 310 in FIG. 3B) for the LLM 304.

At operation 309, the LLM 304 may generate ‘new’ instructions 302 based on the randomly sampled instructions received from the seed instructions 306 and the instruction pool 308. At operation 312, the generated new instructions 302 may be forwarded to a filter 314 configured to perform a filtering on the generated new instructions.

In an embodiment, after the filtering performed by the filter 314, one of the generated new instructions 302 may be added to the instruction pool 308. For example, the filter 314 is a Rogue-L filter. Filtering may correspond to measuring a Rogue-L similarity. In an embodiment, if the Rogue-L similarity of the generated new instruction 302 with any existing instruction (in the instruction pool 308) is less than a threshold (e.g., 0.7), then the generated new instruction 302 may be moved to and stored at the instruction pool 308. If the Rogue-L similarity of the newly generated instruction with any existing instruction is equal to or greater than the threshold (e.g., 0.7), the generated new instruction 302 may be discarded.

Base plan generation is illustrated in FIG. 3B and is described below.

At operations 316, 318, and 320, for each instruction received from the instruction pool 308, based on information on all available devices 322 (i.e., D= [symbol] ), the LLM 304 may generate a device control plan. At operation 316, the ‘in-context examples’ 310 (described above) may be provided to the LLM 304. As shown in FIG. 3B, the LLM 304 may generate “base plans” 324 based on at least three factors, namely, the in-context examples 310, the instruction pool 308, and the information on all available devices ( [symbol] ) 322.

In an embodiment, the base plans 324 may correspond to all available devices ( [symbol] ) 322. With respect to the embodiment shown in FIG. 2, a non-limiting example of the base plans includes: 1. Turn on the ceiling light. 2. Turn on the projector. 3. Turn on the air conditioner. 4. Turn on the window. 5. Turn on the ceiling fan. 6. Turn on the thermostat. 7. Turn off the ceiling light. 8. Turn off the projector. 9. Turn off the air conditioner. 10. Turn off the window. 11. Turn off the ceiling fan. 12. Turn off the thermostat. 13. In an embodiment, above non-limiting examples of the base plans may be generated based on the instruction “The room is too hot”. In an embodiment, the base plans include or correspond to direct instructions and indirect (abstract) instructions.

In an embodiment, the base plans 324 may be generated considering all the possible (e.g. pre-selected) devices are available.

FIG. 2 illustrates that one embodiment of the house room 200 has multiple devices (from the ceiling light 202 to the thermostat 210). In an embodiment of the house room 200, it may be possible that some of the multiple devices become unavailable; for example, the ceiling light 202 and the air conditioner 204 are broken, thus do not function properly. Thus, an embodiment of the disclosure may propose generating other plans (different from the base plans 324) in accordance with different configurations of the environment, such as house room 200. Those other plans are the contrastive plans.’

In an embodiment, the blocks (e.g., the seed instructions 306 to the base plans 324) shown in FIG. 3 may be implemented with computer codes, instructions, or software programs, for example, stored in the memory 130, which are executed by the at least one processor 120. In an embodiment, the blocks may also be physically implemented by analog and/or digital circuits including one or more of a logic gate, an integrated circuit, a microprocessor, a microcontroller, a memory circuit, a passive electronic component, an active electronic component, and the like, and may also be implemented by or driven by software and/or firmware (configured to perform the functions or operations described herein), which may correspond to the components illustrated in FIG. 1. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments shown in FIG. 3 may be physically combined into more complex blocks.

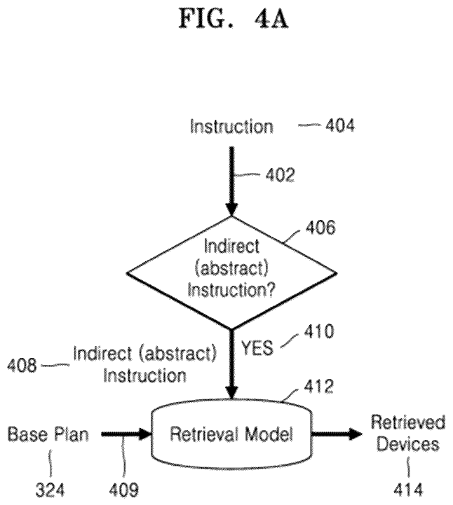

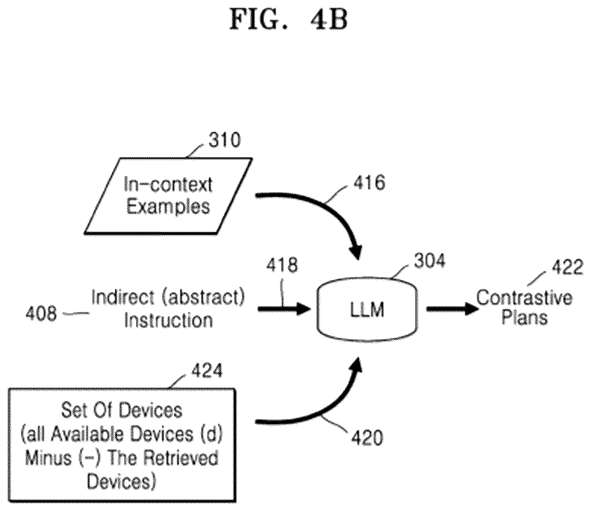

Relevance device retrieval and contrastive plan generation are illustrated in FIG. 4 and are described below.

For example, in a scenario, when the user instruction is “the room is too hot,” a plan (based on the base plans 324) may be an operation of turning on the air conditioner 204. In the scenario, however, the air conditioner 204 may be unavailable to use, instead the ceiling fan 208 is available. In an embodiment, it may be desirable to update the plan to include an operation of turning on the ceiling fan 208.

One possible way is to randomly consider different sets of the available devices and use the LLM 304 to generate additional plans. However, there may be too many possible combinations of all available devices. To learn the configuration dependency, abundant examples may need to be sampled from different combinations of the all available devices. Instead, an embodiment of the disclosure consider different available device combinations based on the base plans 324.

First, in an embodiment, the LLM 304 may be used to divide all the instructions into two types: i) direct instructions, ii) indirect (abstract) instructions. The direct instructions may refer to one or more controlled devices, while the indirect (abstract) instructions do not refer to any specific devices. An example of the direct instructions is “turning on air conditioner,” while an example of the indirect (abstract) instructions is “this room is too hot.”

In FIG. 4A, operation 402 indicates that the instruction 404 is input to the LLM 304. In an embodiment, at operation 406, the LLM 304 may determine whether the instruction 404 is an indirect (abstract) instruction. When the instruction 404 is determined (by the LLM 304) that the instruction 404 is indeed the indirect (abstract) instruction 408 (operation 410), then a retrieval model 412 may be used to generate a set of ‘retrieved devices,’ based on the indirect (abstract) instruction 408 and the base plans 324 (received at operation 409). The retrieval model may be functionally connected with the LLM 304. An example of the retrieval model may be pretrained sentence transformer.

In an embodiment, different plans may be generated based on user preferences and the availability of devices. As shown in FIG. 4A, only indirect (abstract) instructions 408 may be considered for generating contrastive plan generation. The embodiments of the disclosure are to remove some devices from the set of all possible devices 322, based on the base plans 324. When the instruction 404 is the indirect (abstract) instruction 408, based on the base plans 324, the retrieval model 412 is used to generate the set of the retrieve devices 414 corresponding to the indirect (abstract) instruction 408. In an embodiment, the retrieval model 4012 may identify the set of the retrieve devices 414 being used in the base plans 324.

As shown in FIG. 4B, at operations 416, 418, and 420, the LLM 304 may be used to generate the contrastive plans 422, based on the indirect (abstract) instruction 408, the in-context examples 310, and a reduced set of available devices 424 (the all available devices 322 minus (−) the retrieved devices 414). In an embodiment, the LLM 304 may be used to generate new plans (namely, the contrastive plans 422), which are different from the base plans 324, for the same indirect (abstract) instruction 408 and the reduced set of available devices 424. In an embodiment, the reduced set of available devices 424 may refer to an updated list of available devices. By using the reduced set of available devices 424, the LLM 203 may generate a plan for the same instruction with a different set of available devices. In an embodiment, contrastive plans 422 may adjust planning for different home configurations. In an embodiment, contrastive plans 422 may lead to better sensitivity of the LLM 304 for different home configurations.

In an embodiment, the blocks (e.g., 406 to 422) shown in FIG. 4A and FIG. 4B may be implemented with computer codes, instructions, or software programs, for example, stored in the memory 130, which are executed by the at least one processor 120. In an embodiment, the blocks shown in FIG. 4 may also be physically implemented by analog and/or digital circuits including one or more of a logic gate, an integrated circuit, a microprocessor, a microcontroller, a memory circuit, a passive electronic component, an active electronic component, and the like, and may also be implemented by or driven by software and/or firmware (configured to perform the functions or operations described herein), which may correspond to the components illustrated in FIG. 1. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments shown in FIG. 4 may be physically combined into more complex blocks.

### Fine-Tuning of a SLM is Described Below.

As discussed above, the LLM 304 may be used to generate both of the base plans 324 and the contrastive plans 422 for a diverse set of instructions (including the direct instructions and/or the indirect (abstract) instructions). A first set of instruction-device-plan triplets with the base plans 324 and a second set of instruction-device-plan triplets with the contrastive plans 422 may be combined to prepare a device control data set. For fine-tuning of the SLM 502, the device control data set may be randomly split into three different sub-sets, namely, (i) a training set, (ii) a validation set, and (iii) a testing set.

In an embodiment, N triplets {(uᵢ, Dᵢ, Sᵢ)}ᵢ₌₁^{N} may be prepared for fine-tuning the SLM 502 with weights Θ. A standard autoregressive language modeling, which is known in related art, may be used to ‘fine-tune’ the SLM 502, which aims to maximize the following likelihood: [symbol] =Σᵢ₌₁^{N}[log P(Sᵢ|uᵢ, Dᵢ; Θ)]. Here, uᵢ is a user instruction, Dᵢ is a set (a group) of available devices, and Sᵢ is a device control plan/step. As known in the related art, the conditional probability P may be modeled using a neural network with parameters (weights Θ).

The above-described operations for the fine-tuning of the SLM 502 may not be performed by human mental process or human manual operations with pens and paper. Rather, those operations may need to be performed by a specialized (not generic) computer that may have components of the electronic device 101, for example, the processor 120 and the memory 130.

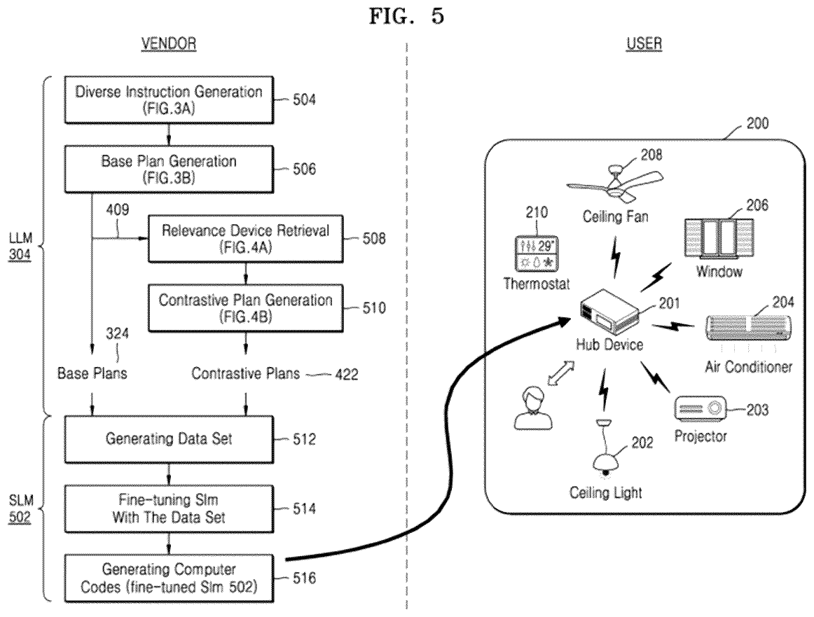

FIG. 5 illustrates embodiments about practical applications of the disclosure. A vendor (a manufacturer, a programmer, a supplier) of computer programs or computer codes may perform operations (504 to 516) shown in FIG. 5, by using the electronic device 101 of FIG. 1. In an embodiment, the operations may be performed by the processor 120, the memory 130, and/or other components of the electronic device 101 of FIG. 1, which is operated by the vendor.

In an embodiment, operation 504 may correspond to the diverse instruction generation shown in FIG. 3A and described above. In an embodiment, operation 506 may correspond to the base band generation shown in FIG. 3B and described above. An output of operation 506 is the base plans 324.

In an embodiment, operation 508 may correspond to the relevance device retrieval shown in FIG. 4A and described above. In an embodiment, operation 510 may correspond to the contrastive plan generation shown in FIG. 4B and described above. An output of operation 510 is the contrastive plans 422.

In an embodiment, at operation 512, the base plans 324 and the contrastive plans 422 may be combined to generate a data set. In an embodiment, the data set may be a set of instructions-devices-plans triplets. At operation 514, the SLM 502 may be fine-tuned with the data set. At operation 516, computer codes corresponding to the fine-tined SLM 502 may be generated.

At operation 518, the generated computer codes may be transferred to the hub device 201. In an embodiment, the vendor may install the generated computer codes into the hub device 201 that is sold to the user. In an embodiment, the user may download the generated computer codes from a cloud system or the server 108, where the generated computer codes are stored by the vendor.

The hub device 201 may correspond to the first electronic device 101. In an embodiment, the hub device 201 may have the input device 150. After the generated computer codes are installed or downloaded in the hub device 201, the hub device 201 may receive, via the input device 150, a verbal instruction (utterance such as ‘this room is too hot’ or ‘turn off the air conditioner’) from a user of the hub device 201. The generated computer codes may be stored in the memory 130 and may be executed by the processor 120. Based on the received verbal instruction, the generated computer codes (corresponding to the fine-tuned SLM 502) may provide an output (or a response) to the received verbal instruction. Then, the output (the response) may be forwarded to application program interfaces (APIs) of the controlled devices (e.g., in FIG. 2 and FIG. 5, 201 to 210), which are stored in the memory 130 and/or in memories of the controlled devices.

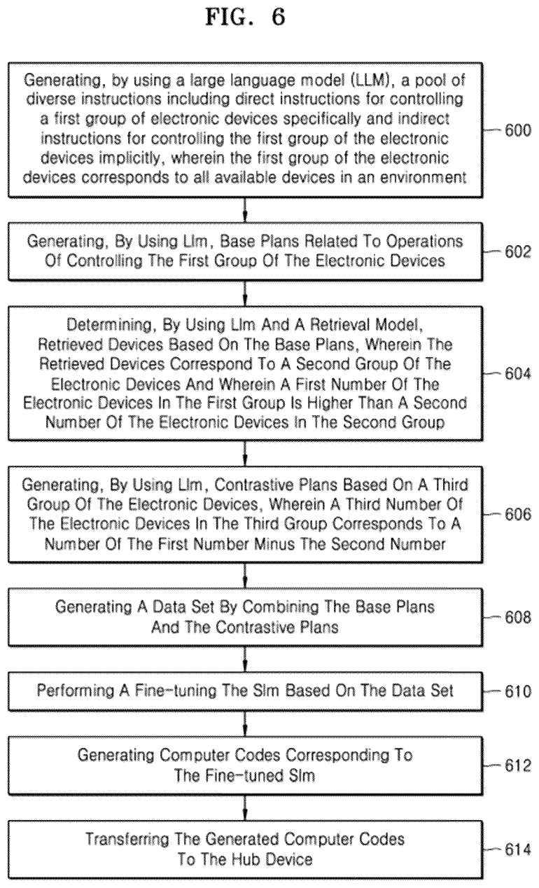

FIG. 6 illustrates operations for generating computer codes corresponding to a fine-tuned SLM having improved device control capabilities and transferring the generated computer codes to a hub device, in accordance with some embodiments of the disclosure.

At operation 600, the operations include generating, by using an LLM, a pool of diverse instructions including direct instructions for controlling a first group of electronic devices and indirect instructions for controlling the first group of the electronic devices. The first group of the electronic devices corresponds to all available devices in the environment.

At operation 602, the operations include generating, by using the LLM, base plans related to operations of controlling the first group of the electronic devices.

At operation 604, the operations include determining, by using the LLM and a retrieval model, retrieved devices based on the base plans. The retrieved devices correspond to a second group of the electronic devices and a first number of the electronic devices in the first group is higher than a second number of the electronic devices in the second group.

At operation 606, the operations include generating, by using the LLM, contrastive plans based on a third group of the electronic devices. A third number of the electronic devices in the third group corresponds to a number of the first number minus the second number

At operation 608, the operations include generating a data set by combining the base plans and the contrastive plans.

At operation 610, the operations include performing a fine-tuning the SLM based on the data set.

At operation 612, the operations include generating computer codes corresponding to the fine-tuned SLM.

At operation 614, the operations include transferring the generated computer codes to the hub device to be connected with a fourth group of the electronic devices in the environment. In an embodiment, descriptions of the data flow diagram described above with reference to FIG. 6 may be omitted for the sake of brevity. In an embodiment, descriptions of the data flow diagram described above with reference to FIG. 6 may be used to implement at least a portion of at least one of the example application of first electronic device 101 and may include additional feature.

Improvements to related computer technologies about controlling devices by language models are described below.

A SLM of the related art may be unable to do device control planning with in-context examples. Whenever prompted with instruction and available list of devices, the SLM may generate steps mostly involving all the available devices, even when the devices are not relevant to the instruction. An LLM of the related art may not generate irrelevant steps for the prompted instruction. However, the LLM may be too resource-demanding, thus may not be transferred to any hub device operatively connected with multiple devices controlled by the hub device. In contrast, the SLM may be relatively lighter, and thus, may be transferrable to the hub device and may work as an on-device AI assistant. In summary, the LLM may have device controlling capabilities, but the LLM may not be transferred to or be installed in an electronic device such as a hub device controlling multiple controlled devices in an environment. The SLM may be transferred to or be installed in the electronic device. However, the SLM may not have device controlling capabilities that properly control the multiple controlled devices in the environment.

The above-described embodiments of the disclosure provide particular technical solutions to the above-noted problems of the related language models, the LLM and SLM. In an embodiment of the disclosure, the SLM is fine-tuned with synthesized triplets having both of the base plans and the contrastive plans, as discussed above. That is, the SLM, which is fine-tuned in accordance with an embodiment of the disclosure, may have device controlling capabilities that properly control the multiple controlled devices in the environment. Also, in an embodiment of the disclosure, the SLM may be transferred to or be installed in the electronic device such as the hub device controlling multiple controlled devices in the environment.

In an embodiment, the above-described embodiments of the disclosure may generate SLM for device control with only abstract instruction. In an embodiment, the SLM may be on-device. In an embodiment, the SLM may be generated by fine-tuning the SLM model with the obtained data set with 1) diverse instruction generation, 2) base plan generation and 3) contrastive plan generation.

In an embodiment, the above-described embodiments of the disclosure may be used in a single room or/and a house with multiple rooms. In an embodiment, the above-described embodiments of the disclosure may be used to perform planning tasks where plans are inter-dependent on devices from different rooms.

In an embodiment, the above-described embodiments of the disclosure may accommodate the need of user preferences. Preferences may vary from user to user. The disclosure may be equipped with online adaptation system that will learn from user interactions and preferences. In an embodiment, the generated plan may be more personalized.

For example, computer codes corresponding to the SLM fine-tuned with the synthesized triplets (having both of the base plans and the contrastive plans) result in significant improvement of evaluation scores (obtained by well-known evaluation metrics such as BLEU and ROUGE) than other computer codes corresponding to the SLM fine-tuned with data set having only the base plans or other computer codes corresponding to the SLM fine-tuned with data set having the base plans and random plans.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication circuit, and entering the received data into the data input field.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

1. A method for enabling an improved device control capability of a small language model (SLM), the method comprising:
generating, by using a large language model (LLM), a pool of diverse instructions including direct instructions for controlling a first group of electronic devices and indirect instructions for controlling the first group of the electronic devices, wherein the first group of the electronic devices corresponds to all available devices in the environment;
generating, by using the LLM, base plans related to operations of controlling the first group of the electronic devices;
determining, by using the LLM and a retrieval model, retrieved devices based on the base plans and the indirect instructions, wherein the retrieved devices correspond to a second group of the electronic devices and wherein a first number of the electronic devices in the first group is higher than a second number of the electronic devices in the second group;
generating, by using the LLM, contrastive plans based on a third group of the electronic devices, wherein a third number of the electronic devices in the third group corresponds to a number of the first number minus the second number;
generating a data set by combining the base plans and the contrastive plans;
performing a fine-tuning the SLM based on the data set;
generating computer codes corresponding to the fine-tuned SLM; and
transferring the generated computer codes to the hub device to be connected with a fourth group of the electronic devices in the environment.

2. The method of claim 1, wherein the generating, by using the LLM, the pool of diverse instructions comprises:
receiving seed instructions;
generating, by using the LLM, instructions based on the received seed instructions;
filtering, by using a filter, the generated instructions; and
storing the filtered instructions in the pool of diverse instructions.

3. The method of claim 2, wherein the filter is a Rogue-L filter.

4. The method of claim 3, wherein the filtering the generated instructions comprises:
measuring a Rogue-L similarity between one instruction of the generated instructions and an existing instruction in the pool of diverse instructions, and
storing the one instruction of the generated instructions in the pool of diverse instructions when the measured Rogue-L similarity is equal to or greater than a pre-determined threshold.

5. The method of claim 2, wherein the generating, by using the LLM, the base plans comprises providing, to the LLM, in-context examples, the pool of diverse instructions, and a list of all controlled devices in the environment.

6. The method of claim 5, wherein the in-context examples comprise a first group of instructions randomly sampled from the seed instructions and a second group of instructions randomly sampled from the pool of diverse instructions.

7. The method of claim 1, wherein the determining, by using the LLM and the retrieval model, retrieved devices comprises determining, by using the LLM, whether an instruction provided to the LLM is one of the indirect instructions.

8. The method of claim 1, the retrieval model is operatively connected with the LLM and is a pretrained sentence transformer.

9. The method of claim 1, wherein the generating, by using the LLM, the contrastive plans based on the third group of the electronic devices, comprises providing, to the LLM, in-context examples and the indirect instructions to the LLM.

10. The method of claim 1, wherein the data set comprises a plurality of instructions-devices-plans triplets.

11. The method of claim 1, wherein the performing the fine-tuning the SLM comprises maximizing a likelihood [symbol] =Σᵢ₌₁^{N}[log P(Sᵢ|uᵢ, Dᵢ; Θ)] wherein uᵢ is an user instruction, Dᵢ is a group of available devices, and Sᵢ is a device control plan/step, and P is a conditional probability P modeled using a neural network with parameters Θ.

12. A method for enabling an improved device control capability of a first language model transferrable to a hub device configured to be operable by a user in an environment, the method comprising:
generating, by using a second language model, a pool of diverse instructions including direct instructions for controlling a first group of electronic devices and indirect instructions for controlling the first group of the electronic devices, wherein the first group of the electronic devices corresponds to all available devices in the environment;
generating, by using the second language model, first plans related to operations of controlling the first group of the electronic devices;
determining, by using the second language model and a retrieval model, retrieved devices based on the first plans and the indirect instructions, wherein the retrieved devices correspond to a second group of the electronic devices and wherein a first number of the electronic devices in the first group is higher than a second number of the electronic devices in the second group;
generating, by using the second language model, second plans based on a third group of the electronic devices, wherein a third number of the electronic devices in the third group corresponds to a number of the first number minus the second number;
generating a data set by combining the first plans and the second plans;
performing a fine-tuning the first language model based on the data set;
generating computer codes corresponding to the fine-tuned first language model; and
transferring the generated computer codes to the hub device to be connected with a fourth group of the electronic devices in the environment.

13. An electronic device for enabling an improved device control capability of a small language model (SLM), the electronic device comprising:
at least one processor comprising processing circuitry; and
at least one memory including one or more instructions, which executed by the at least one processor individually or collectively, to cause the electronic device to at least:
generate, by using a large language model (LLM), a pool of diverse instructions including direct instructions for controlling a first group of electronic devices and indirect instructions for controlling the first group of the electronic devices, wherein the first group of the electronic devices corresponds to all available devices in the environment;
generate, by using the LLM, base plans related to operations of controlling the first group of the electronic devices;
determine, by using the LLM and a retrieval model, retrieved devices based on the base plans and the indirect instructions, wherein the retrieved devices correspond to a second group of the electronic devices and wherein a first number of the electronic devices in the first group is higher than a second number of the electronic devices in the second group;
generate, by using the LLM, contrastive plans based on a third group of the electronic devices, wherein a third number of the electronic devices in the third group corresponds to a number of the first number minus the second number;
generate a data set by combining the base plans and the contrastive plans;
perform a fine-tuning the SLM based on the data set;
generate computer codes corresponding to the fine-tuned SLM; and
transfer the generated computer codes to the hub device to be connected with a fourth group of the electronic devices in the environment.

14. The electronic device of claim 13, wherein the at least one memory including one or more instructions, which executed by the at least one processor individually or collectively cause the electronic device further to generate, by using the LLM, the pool of diverse instructions by:
receiving seed instructions;
generating, by using the LLM, instructions based on the received seed instructions;
filtering, by using a filter, the generated instructions; and
storing the filtered instructions in the pool of diverse instructions.

15. The electronic device of claim 14, wherein the filter is a Rogue-L filter.

16. The electronic device of claim 15, wherein the at least one memory including one or more instructions, which executed by the at least one processor individually or collectively, cause the electronic device further to filter the generated instructions by:
measuring a Rogue-L similarity between one instruction of the generated instructions and an existing instruction in the pool of instructions, and
storing the one instruction of the generated instructions in the pool of diverse instructions when the measured Rogue-L similarity is equal to or greater than a pre-determined threshold.

17. The electronic device of claim 14, wherein the at least one memory including one or more instructions, which executed by the at least one processor individually or collectively cause the electronic device further to generate, by using the LLM, the base plans by providing, to the LLM, in-context examples, the pool of diverse instructions, and a list of all controlled devices in the environment.

18. The electronic device of claim 17, wherein the in-context examples comprise a first group of instructions randomly sampled from the seed instructions and a second group of instructions randomly sampled from the pool of diverse instructions.

19. The electronic device of claim 13, wherein the at least one memory including one or more instructions, which executed by the at least one processor individually or collectively cause the electronic device further to determine, by using the LLM and the retrieval model, retrieved devices by determining, by using the LLM, whether an instruction provided to the LLM is one of the indirect instructions.

20. The electronic device of claim 13, the retrieval model is operatively connected with the LLM and is a pretrained sentence transformer.
